(19) United States
(12) Patent Application Publication
(10) Pub. No.: US 2008/0241453 A1
(43) Pub. Date: Oct. 2, 2008

(54) FRAGRANCE ADVERTISING ASSEMBLY

(76) Inventors: Gary L. Akins, Chattanooga, TN (US); Lyudmila Feldman, Chattanooga, TN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/690,990

(22) Filed: Mar. 26, 2007

(51) Int. Cl. B32B 9/00; B41M 3/12

(52) U.S. Cl. 428/40.2; 427/147

(57) ABSTRACT

Fragrance advertising device comprising two surfaces cojoined with a pattern of adhesive with frangible fragrance containing microcapsules incorporated in a formation of peelable bond.

Microencapsulated fragrance formulation acts as an adhesive surrounding space that is reserved for extra message or an additional art on both of the surfaces inside the device. Improved fragrance rendition characteristics are also achieved with inventive design.

### BACKGROUND OF THE INVENTION

This invention relates to a fragrance advertising assembly or sample with fragrance release and additional advertising space in between.

Manufacturers of a variety of products, especially perfume and other cosmetics, often seek new ways of advertising their products through interactive sampling devices that are suitable and acceptable for publication in catalogs, magazines, mailer cards, and the like.

Not only do interactive devices allow potential customers to sample a product, these devices also serve an important advertising function. For example, artwork or advertising text is often printed on sampler devices before their distribution. Effective artwork can attract attention to the sampler device, entice a potential customer to try the sample, and thereby gain new customers for the manufacturer of the sampled product. Widespread distribution of these sampler devices and effective methods for their mass manufacturing, especially as part of the printing process, are therefore highly desirable.

In addition, in order to catch and maintain the interest of present and potential customers, variety in the types and looks of sampler devices is necessary.

The most common fragrance advertising device, known in the art as a ScentStrip®, generally comprises a sheet of paper, which has been folded one or more times to create panels, and a microencapsulated fragrance contained between the panels of the paper sheet. The panels are releasably attached or fastened, such that the consumer can lift one of the panels to access the fragrance when desired. Alternatively, one of the panels can be perforated such that the consumer removes a tear strip or zip strip to access the sample material.

A typical capsule coating is made as disclosed in U.S. Pat. No. 4,487,801 (Turnbull et al.). Microencapsulated fragrance containing adhesive is normally applied as a relatively wide rectangular stripe down the middle of the paper and the paper folded sharply around the stripe. Upon drying, the separation of the facing panels bursts microcapsules and releases fragrance into the atmosphere.

More examples of longitudinal stripe or stripes applications are found in U.S. Pat. No. 5,188,236 (Sayers, et al.—FIG. 3); U.S. Pat. No. 4,988,557 (Charbonneau); U.S. Pat. No. 5,992,889 (Barnett, et al.—FIGS. 1b, 3, 4b and 5); U.S. Pat. No. 4,419,958 (Charbonneau—FIGS. 8 and 11).

Alternatively, the microencapsulated fragrance containing adhesive pattern may have the shape of a shorter rectangle or circle underneath of a patch, instead of a fold, as in U.S. Pat. No. 5,992,889 (Barnett, et al.—FIG. 7a), and U.S. Pat. No. 5,419,958 (Charbonneau—FIG. 1), or in a two-part pressure sensitive label arrangement as in U.S. Pat. No. 4,606,956 (Charbonneau—FIG. 1; Col 6, lines 48-57) and U.S. Pat. No. 4,769,264 (Dreger—FIG. 1; Col 8, lines 49-50), or as in pads U.S. Pat. No. 4,661,388 (Charbonneau—FIGS. 1 and 2; Col 6, lines 48-57).

One of the deficiencies of the microencapsulated fragrance releasing graphic art articles of the prior art is in that the area of the advertising page that bears the microencapsulated fragrance is not printed with ink. The blank area often results in a harsh visual contrast to the overall appearance and graphic design of the advertisement. The blank area on the page also renders a significant portion of the piece unavailable for additional graphics or text messages to the advantage of advertisers.

The reason for this omission is the undesirable interaction (chemical, mechanical and olfactory) of printing inks with fragrance and other components in frangible adhesive microcapsule composition, which is described in U.S. Pat. No. 5,268,214 to Charbonneau.

This is because water-based slurry cannot be coated easily onto surfaces printed with inks. Ink tends to repel water. Moreover, even if slurry deposit on top of the printed ink is achieved, ink layer presents a substantial barrier, that prevents water from being quickly absorbed into paper followed by gradual evaporation and drying, which is necessary for forming dry bond between the assembly components, including bond between paper and microcapsules, as well as the bond between the microcapsules themselves. Furthermore, even if adhesion problem is solved, essential oils that are released from microcapsules when fragrance is actually tested by a consumer may attack ink, resulting in ink bleeding and smear. In addition, hidden ink odor may intermix with wet fragrance scent, which would result in impaired rendition. Additionally, microcapsules light scattering properties make them opaque. Therefore, microcapsules deposit on top of ink printed art make such art hardly visible and unattractive, which defeats the whole purpose of adding such print whatsoever. Several patents address adhesion and interaction of fragrance with ink.

U.S. Pat. No. 5,268,214 (Charbonneau) discloses the use of a protective treatment between the printing inks on the paper and the microcapsule-containing layer as a solution to the prior art problem. However, this method imposes such limitations as an additional cost in materials and manufacturing that requires careful selection of polymers, polymer solvents, curing conditions, such that a satisfactory balance in adhesion and interaction of paper, inks, protective coating and microencapsulated fragrance containing adhesive would be achieved. There is also additional capital equipment and energy cost associated with installation of an appropriate protective treatment casting equipment, controls and large scale industrial dryers to be added to printing press to accomplish the process.

U.S. Pat. No. 4,925,517 also discloses the use of a base coating on a surface to be subsequently coated with a microcapsule-bearing layer. The base coating functions in part to control adhesion between the underlying paper and microcapsules layer. By printing the base coat adhesive composition in a discontinuous maimer, the opposed faces will be adhered only in those areas where the base coat adhesive has been printed. The slurry carrying medium is usually a solvent for the base coat adhesive in this embodiment. The microcapsules will lightly adhere to the faces of the sheet, but will not rupture upon separation of the opposed faces. This will allow for reuse of the fragrance, i.e., additional microcapsules can be ruptured by scratching after the sheets have been separated.

U.S. Pat. No. 4,988,557 discloses a similar carrier activated base coating that is applied in a discontinuous pattern to provide separate areas of the sampler in which the capsules are ruptured when the piece is opened, as well as regions in which the microcapsules may be freely removed. In this case, microencapsulated composition covers the entire middle section, where stripes or other patterns of adhesion strength are created by previously applied and dried coating.

Another deficiency of prior art fragrance samplers of the type discussed above is that, during application of water-based slurry to paper in a form of a continuous strip, the large amount of water in one single area leads to undesirable paper swelling which results in a “puckered” appearance when dried. More importantly, high concentration of moisture tends to re-activate “paper odor” which becomes entrapped between panels, and later, freed when sampler is opened and blends with fragrance causing less than desirable performance of fragrance sampler. In addition, such high concentration of moisture can disrupt the delicate balance in bond strengths between paper, paper coating, and capsules with detrimental effect on sampler performance.

These and other deficiencies in fragrance samplers of the prior art create the need for a device with improved aesthetics and performance characteristics in a market that places a premium on appearance and function.

It has been discovered by the present inventor that the appearance of the fragrance advertising page with microencapsulated fragrance release can be improved such that the additional space to be printed with ink in the previously unavailable area is provided without any additional expenses, or changes in microcapsules containing adhesive, or ink, or paper.

It has further been discovered by the present inventor that the performance of the fragrance advertising page of the present invention has been markedly enhanced by controlling the total area and pattern of the microencapsulated fragrance containing adhesive placed on the device as discussed in detail below.

These and other advantages of the present invention will be apparent from the description of the invention provided herein.

### SUMMARY OF THE INVENTION

The present invention provides a fragrance advertising page of improved appearance and performance by providing a premium space for additional art work or messages without loss of functionality and quality of fragrance release by rupturing the adhesive comprising fragrance containing microcapsules which temporarily adheres two surfaces of the folded panels of the sheet, or two separate sheets.

The present invention also relates to methods of making such advertisement pages.

The fragrance advertising page of the present invention comprises two surfaces adhered to each other by a miicroencapsulated fragrance containing adhesive slurry, wherein at least a portion of the microcapsules are broken when the surfaces are separated, and wherein said slurry is applied in a pattern which substantially defines the premium space for additional art work in between.

It has been also discovered that by defining parameters for the area covered with microencapsulated fragrance containing adhesive slurry and the area defined as premium space thereby, the present invention results in more pleasing overall impression, including improved rendition of fragrance, which is an ultimate goal of such advertisement.

### BRIEF DESCRIPTION OF THE DRAWINGS

Reference is next made to a brief description of the drawings, which are intended to illustrate several embodiments of the fragrance advertising page and the method of making the fragrance advertisement page according to the present invention. The drawings and detailed descriptions which follow are intended to be merely illustrative, and are not intended to limit the scope of the invention as set forth in the appended claims.

FIG. 1a is a plan view of a first embodiment of the fragrance advertising page in which the panels of the carrier sheet are open;

FIG. 1b is a plan view of a first embodiment of the fragrance advertising page in which the panels are closed;

FIG. 1c is a cross-sectional view of the first embodiment of the fragrance advertising page, as shown in FIG. 1b, prior to opening;

FIG. 2 is a cross-sectional view of a second embodiment of the fragrance advertising page prior to opening;

FIG. 2(a) is a cross-sectional view of a variation of the second embodiment of the fragrance advertising page prior to opening;

FIG. 3 is a cross-sectional view of a third embodiment of the fragrance advertising page prior to opening;

FIG. 4 is a plan view of a fourth embodiment of the fragrance advertising page;

FIG. 5 is a plan view of the fifth embodiment of the fragrance advertising page;

FIG. 6 is a plan view of the sixth embodiment of the fragrance advertising page;

FIG. 7 is a plan view of the seventh embodiment of the fragrance advertising page;

FIGS. 8a and 8b are plan views of the eighth embodiment of the fragrance advertising page;

FIG. 9 is a cross-sectional view of the eighth embodiment of the fragrance advertising page, prior to opening;

FIG. 10 is a plan view of a ninth embodiment of the fragrance advertising page; and

FIG. 11 is a plan view of a variation of the ninth embodiment of the fragrance advertising page; and

FIG. 12 is a plan view of a tenth embodiment of the fragrance advertising page.

### DESCRIPTION OF THE PREFERRED EMBODIMENTS

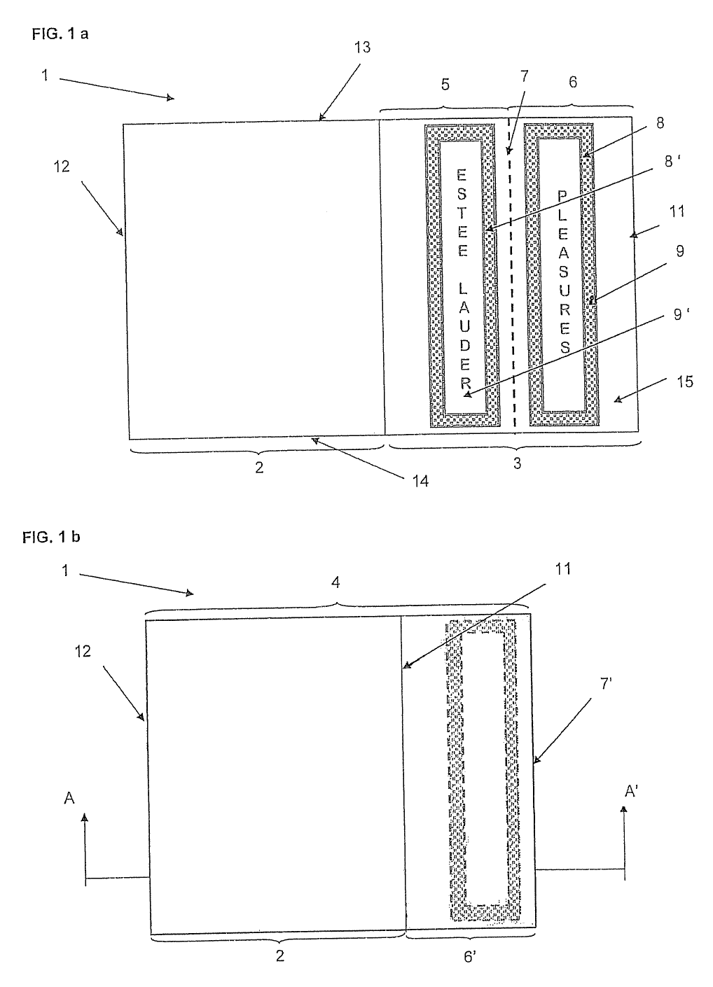

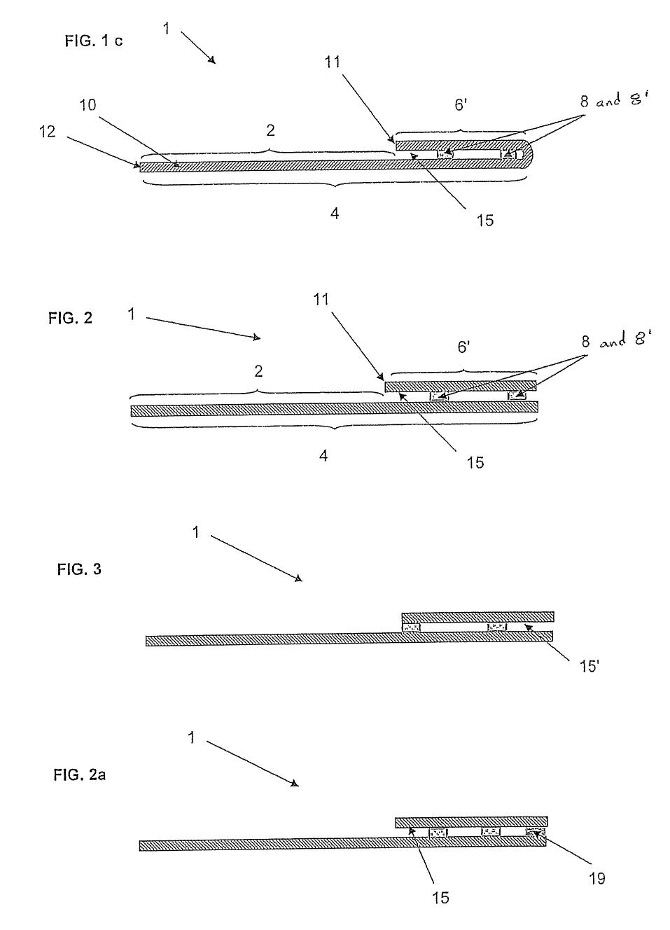

FIGS. 1a, 1b and 1c represent a fragrance advertising page 1 according to the first embodiment of the present invention. As best shown in FIGS. 1a and 1c, the fragrance advertising page 1 comprises a carrier sheet 10 that is folded upon itself, forming two panels: panel 4 and panel 6. The carrier 10 is made from a relatively thin flexible sheet material such as paper, plastic or a composite. Further, FIG. 1a shows that the carrier 10 comprises a flat sheet with four edges 11, 12, 13 and 14 and several segments. Segment 2 is printed with advertisement and art, and segment 3 is customarily not printed with ink, but is instead reserved for a microencapsulated fragrance containing adhesive, sometimes referred to herein as a “slurry”. Segment 3 additionally comprises two sub-sections: segment 5 (of panel 4) and panel 6, which are separated by a fold line 7.

In the first embodiment of the invention, the microencapsulated fragrance containing adhesive slurry is placed on the top surface of panel 6 to define an outer pattern 8, shown in the shape of an elongated frame. The mirror outer pattern 8′ on the segment 5 of the panel 4 is a footprint of the outer pattern 8 that develops when panel 6 is folded and pressed onto the panel 4. Alternatively, the mirror outer pattern 8′ may be deposited on panel 4 simultaneously with the outer pattern 8 on the top surface of panel 6. Application of the outer pattern 8 and 8′ also substantially defines inner patterns 9 and 9′ constitute premium space for additional printing with ink not present in the prior art. As shown in the particular example in FIG. 1a, both inner patterns 9 and 9′ are used for printing the name of the fragrance and the designer.

FIG. 1b illustrates a face-up appearance of the fragrance advertising page 1 as a finished product, wherein the panel 6 is closed and attached to the panel 4, with the microcapsule bearing adhesive slurry outer pattern 8 and 8′ (shown in phantom). In this form, only segment 2 and the bottom surface of panel 6, separated by the edge 1 1 are visible. A lip area 15 is provided as shown surrounding the adhesive bands 8 and 8′ to facilitate separation of panel 6 from segment 5 of panel 4 when desired. The lip area 15 (see FIG. I c) constitutes an outer region which may or may not contain additional graphics.

FIG. 2 shows a cross-sectional view of the second embodiment of the fragrance advertising page 1 where the panels 4 and 6 are severed from each other and comprise two separate sheets.

FIG. 2(a) shows a cross-sectional view of a variation of the second embodiment of the fragrance advertising page 1 where the panels 4 and 6 comprise two separate sheets but are joined together along a line of permanent or re-closable glue 19.

It should be noted that the panels 4 and 6 in all the embodiments of the invention can be separable or non-separable with a permanent hinge (which could be a fold line) or with an adhesive, staple, tape or the like. All such constructions are considered to be within the scope of the present invention.

FIG. 3 shows a cross-sectional view of the third embodiment of the fragrance advertising page 1 where panels 4 and 6 are also made of two separate sheets, but a modification of the lip 15 is facing toward the outer edge of the page.

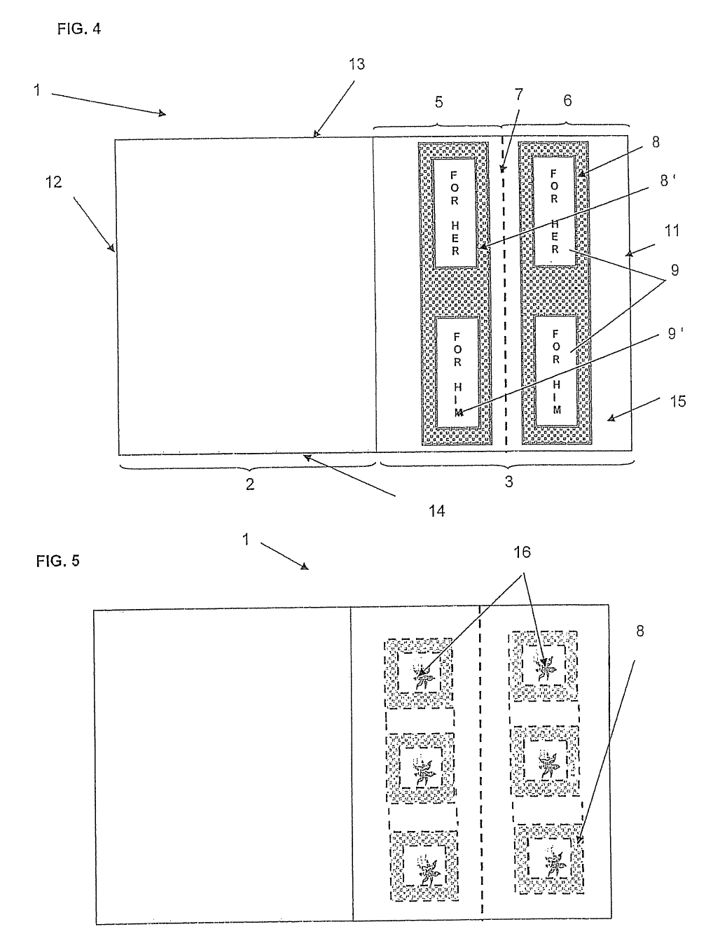

Many other variations in design are also available. For example, the slurry may be applied to form outer patterns 8 and 8′ to define divided inner patterns 9 and 9′, as shown in FIG. 4.

FIG. 5 shows the another embodiment, in which the slurry is applied in yet another manner to form outer patterns 8 and 8′ which substantially define inner patterns 9 and 9′ that can be printed with graphics 16. With respect to this embodiment, it is important to note that the inner patterns 9 and 9′ are meant to include not only the areas inside of the three(3) sub-rectangles which are totally surrounded by the slurry, but also the two(2) areas between the sub-rectangles. That is, the outer patterns 8 and 8′ are intended to extend along the phantom lines shown between the three(3) sub-rectangles and, if desired, graphics 16 can be printed in the areas shown between the three(3) sub-rectangles, as well.

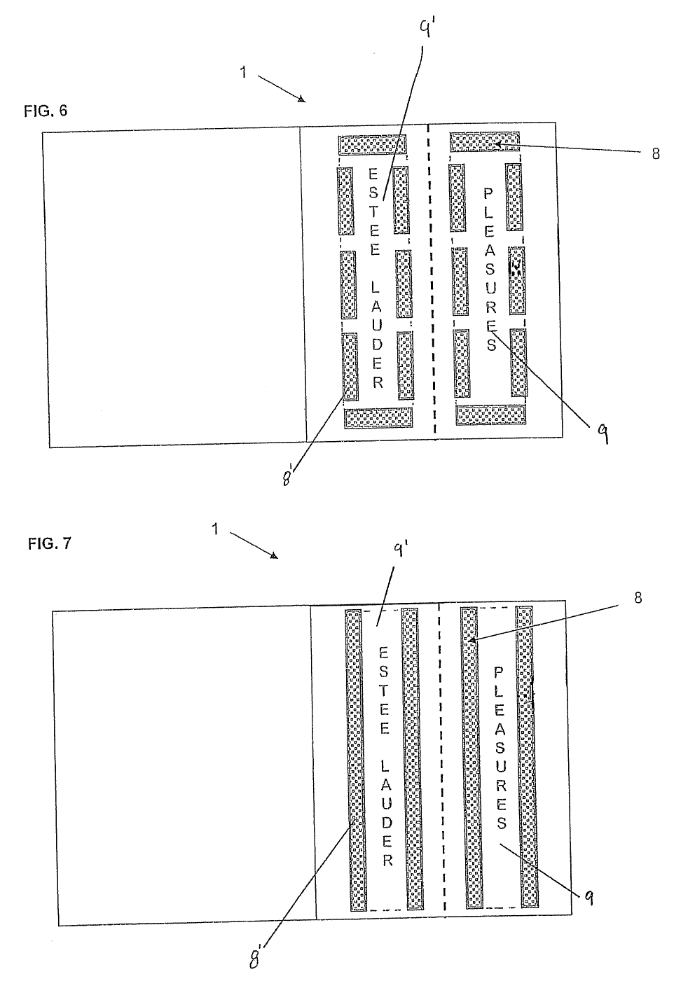

In addition, the outer patterns 8 and 8′ may include discontinuous segments of slurry and be applied as shown in the examples of FIG. 6 and 7 without departing from the spirit and scope of the invention. It is also contemplated that microcapsule containing adhesive slurry may be colored, tinted or sparkled. Again, in the embodiments of FIGS. 6 and 7, the inner patterns 9 and 9′ are meant to include not only the areas within the inside boundaries of the discontinuous segments of slurry, but also the areas between the discontinuous segments of slurry.

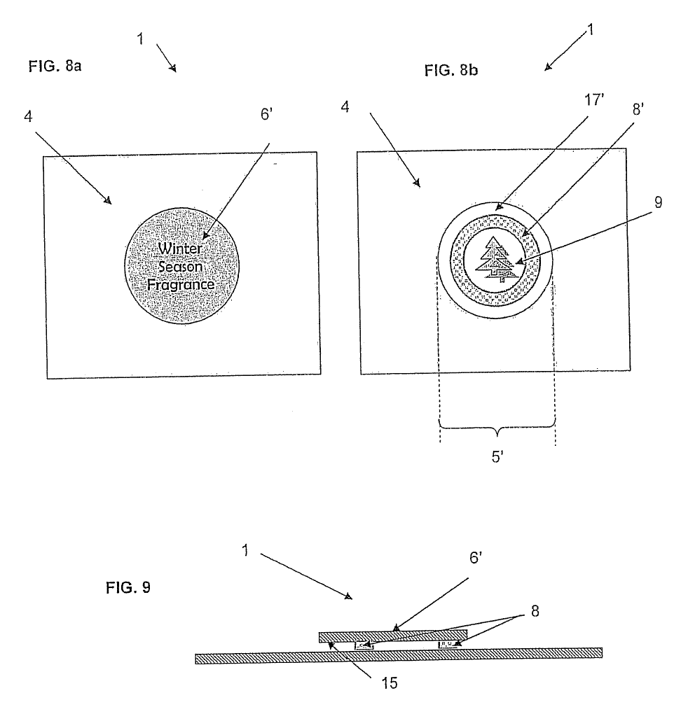

Moreover, the segment 5 of the fragrance advertising page 1 does not necessarily have to be adjacent to any specific edge of the page, and can be of any shape. For example, it can be round and be positioned in the middle of the carrier, as shown in the embodiment of FIGS. 8a and 8b. Also, the panel 6 also may have various shapes. In FIG. 8a it is shown as a round patch with print on its bottom side. It is attached to the carrier with a circular band of the microencapsulated fragrance containing adhesive, while covering segment 5. FIG. 8b also shows a circular margin 17′, which may or may not be reserved for separation between the microcapsules containing adhesive and the rest of the page. It is important, however, that the panel 6 dimensions and position are selected in such a proportion to the adhesive that there is adequate lip area 15 for grabbing and peeling it off is provided (See FIG. 9).

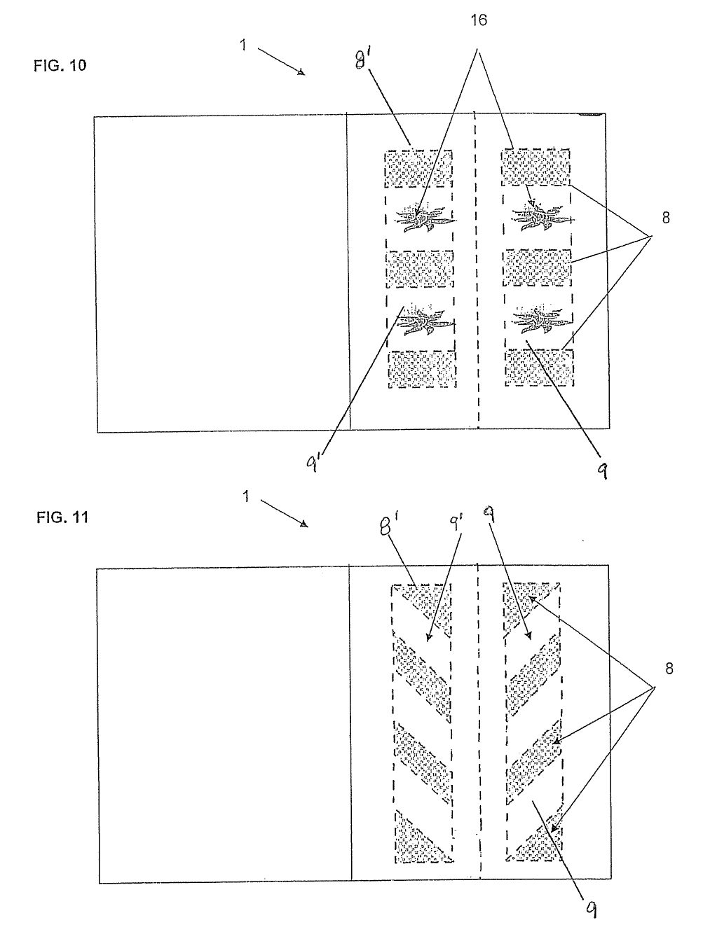

FIGS. 10 and 11 show a ninth embodiment of the present invention wherein the outer patterns 8 and 8′ of adhesive slurry are deposited on the panels 4 and 6 in a pattern of geometric shapes which can be consistent, as shown in FIG. 10, or variable, as shown in FIG. 11. The embodiment of FIGS. 10 and 11 also illustrate the location of graphic patterns 16 printed within the inner patterns 9 and 9′. It should also be noted that the geometric shapes of the outer patterns 8 and 8′ shown in FIGS. 10 and 11 can consist of differing slurries having different adhesive and microcapsules containing different fragrance oils, all of which combinations are considered to be included in the scope of the present invention.

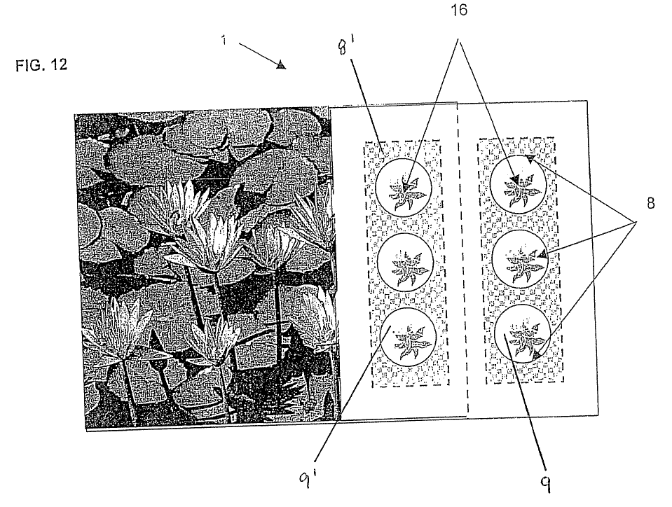

FIG. 12 shows a tenth embodiment of the present invention wherein the outer patterns 8 and 8′ of adhesive slurry surround the circular inner patterns 9 and 9′ as shown.

As noted above, the disclosed embodiments of the present invention also result in providing an improved fragrance rendition. Although, the exact mechanism is unknown, the following combination of factors contributes to the improved fragrance rendition achieved by the present invention namely, spatial distribution of moisture and spatial distribution of fragrance release elements.

It is well known (especially in a food packaging field) that any paper, after re-moistening tends to release hidden odors. Same potentially happens when a water-based adhesive slurry 8 is enclosed within folded panels, 4 and 6. A freshly printed microcapsule slurry contains 70-80 or more percent water that is imbibed within paper. It stays there until product dries. Typically, it takes several hours of natural drying, during which water has a good chance to re-solubilize odorous components in paper, or reactivate dormant biological agents (molds or bacteria) that are a usual source of off odor. Then, as the panels, 4 and 6 are unfolded during the fragrance test, some of the trapped paper malodor escapes into the atmosphere blending with fragrance odor that is simultaneously released from ruptured microcapsules. In drying, some amount of moisture also tends to migrate side-wise within paper, which minimizes its concentration in one spot and facilitates faster drying. The limitation of the art is that it provides only four edges (or fronts) for lateral moisture migration, while the present invention, more edges with appropriate inner regions between them are provided. Conceptually, this change should facilitate less moisture concentration in certain areas (such as a middle in the old printed strip), and faster drying through dissipation. Both phenomena work to minimize both off-odor and paper distortion.

In addition, higher moisture content in corresponding areas of slurry on paper tends to weaken the bond between paper coating and paper base sheet. As result, when two parts of the sheet 1 are pulled apart, paper coating (clay or calcium carbonate) tends to delaminate from paper, staying on top of microcapsules. In such spots fragrance release is obstructed, or in extreme cases is totally blocked. Worse yet, more released paper odor unobtrusively blends with the fragrance during consumer's test.

With regard to the spatial distribution of fragrance release elements, the proposed explanation is based on a fact that perception of fragrance odor relates to a size of area from which it emanates. In the present invention, the fragrance and air mixture from a larger fragrance encircled area tends to provide a better smelling experience than the same amount of fragrance releasing from a single concentrated area (as in prior art). In this regard, it has also been found that improved fragrance rendition results when the area of the outer pattern 8 is no more than 90% and no less than 30% of the combined total area of the outer pattern 8 and the inner pattern 9. Maximum fragrance rendition performance is achieved when the inner pattern is between 35% and 65% of the combined total area of the outer pattern 8 and the inmer pattern 9.

The present invention also relates to method of making fragrance advertising page 1. Specifically, it comprises a patterned adhesive application design with a purpose to include printing with ink in the adhesive free areas. It also comprises the method of preparing and printing such pattern. In one embodiment such a method comprises printing with pre-cut pad. Various designs of microcapsules containing adhesive application pad can be cut out from commercially available pre-manufactured sheets commonly known as glue pads.

The preferred method of making fragrance advertising pages according to the present invention is a continuous process which yields a large number of fragrance advertising pages easily and at high speed. To insure consistency, multiple pads of the same shape are pre-cut using a specialized die, which could be a flat or a rotary die. It is also a subject of the present invention to use laser-cut pads.

Other contemplated methods of patterned adhesive application methods include silk screening, spray application using template, extrusion and lamination.

There are three conditions that should be met in executing the present invention. One condition is an appropriate releasable bond between two joined panels. The second condition is that pad design provides an adhesive encircled space for printing with ink(, and the third condition is that the fragrance release upon separation of the two joined panels satisfies fragrance advertisers requirements for fragrance rendition and strength.

In the preferred embodiment the manufacturing process includes printing ink in all areas simultaneously. It is contemplated, however, that the printing in the inner pattern 9 can be accomplished in a separate step. This may be particularly desired when an additional print station is used for printing of personalized messages.

The invention is claimed as follows:

1. An advertising format comprising:
at least a first and a second panel of ink-printable sheet material;
a slurry containing a combination of adhesive and microencapsulated fragrance;
said slurry being deposited on at least one of said first and second panels of sheet material in a outer pattern which defines an ink-printable inner pattern void of said slurry.

2. An advertising format as recited in claim 1, wherein at least some portion of said first panel is bonded to at least some portion of said second panel along said outer pattern.

3. An advertising format as recited in claim 1, wherein the outer pattern of slurry is deposited on at least one of said first and second panels of sheet material such that the area of the outer pattern is no more than 90% and no less than 30% of a combined total area of the outer pattern and the inner pattern.

4. An advertising format as recited in claim 1, wherein said slurry a substantially uniform moisture content distribution throughout the outer pattern to improve fragrance rendition performance characteristics.

5. An advertising format as recited in claim 1, wherein the inner pattern is between 35% and 65% of a combined total area of the outer pattern and the inner pattern.

6. A method of manufacturing an advertising format comprising the steps of:
providing at least a first and a second panel of ink-printable sheet material;
depositing a slurry containing a combination of adhesive and micro encapsulated fragrance on at least one of said first and second panels of sheet material in an outer pattern which defines an inner pattern;
printing ink graphics on at least some portion of said inner pattern; and
bonding at least some portion of said first panel to at least some portion of said second panel along said outer pattern.

7. A method of manufacturing an advertising format as recited in claim 6, wherein said depositing step comprises applying said slurry such that the area of the outer pattern is no more than 90% and no less than 30% of a combined total area of the outer pattern and the inner pattern.

8. A method of manufacturing an advertising format as recited in claim 6, wherein said depositing step comprised applying said slurry such that a substantially uniform moisture content distribution throughout the outer pattern is achieved to improve fragrance rendition performance characteristics.

9. A method of manufacturing an advertising format as recited in claim 6, wherein said depositing step defines an inner pattern that is between 35% and 65% of a combined total area of the outer pattern and the iimer pattern.
